(19) United States
(12) Patent Application Publication
(10) Pub. No.: US 2025/0256861 A1
(43) Pub. Date: Aug. 14, 2025

(54) AVIATION WHEEL CHOCK

(71) Applicant: Checkers Industrial Products, LLC, Broomfield, CO (US)

(72) Inventors: Greg Widgery, Broomfield, CO (US); Jacob Meister, Broomfield, CO (US)

(73) Assignee: Checkers Industrial Products, LLC, Broomfield, CO (US)

(21) Appl. No.: 18/436,211

(22) Filed: Feb. 8, 2024

(51) Int. Cl. B64F 1/16; B60T 3/00

(52) U.S. Cl. CPC B64F 1/16; B60T 3/00

(57) ABSTRACT

A reversible wheel chock can include a body portion having: a bottom face; a front face and a rear face extending upward relative to the bottom face, the front face having a front wall height, and the rear face having a rear wall height equivalent to the front wall height; a spine forming a top surface parallel to the bottom face, the spine defining apertures; a first chocking face spanning a first surface distance between the spine and the front face; and a second chocking face spanning a second surface distance between the spine and the rear face. The first surface distance and the second surface distance can be between 3 and 4 times greater than the front and rear wall heights. A handle can be attachable to the body portion via the apertures. A base pad can be attached to the body portion adjacent to the bottom face.

### FIELD

The described examples relate generally to wheel chocks. In particular examples, the disclosure relates to aviation wheel chocks with improved compatibility with different aircraft sizes.

### BACKGROUND

Wheel chocks can include wedges of material to place closely against the wheels of a vehicle to prevent unintended movement or rotation of the wheels. In some examples, wheel chocks are used in combination with brakes (e.g., parking brakes) to prevent accidental movement of the vehicle when the vehicle is intended to remain stationary. Wheel chocks can be used in many different industries. In some examples, wheel chocks are used in the aviation industry to help maintain an aircraft in position (e.g., when parked in a hangar, during maintenance procedures, or when loading or boarding an aircraft). In other examples, wheel chocks are used in heavy industrial applications such as in mining, shipping, and construction in order to keep tractors, trucks, cranes, and other wheeled vehicles from moving when parked.

In the aviation industry, a variety of different wheel chocks—including wheel chocks of different sizes—are commonly implemented to account for different aircraft sizes. For example, conventional wheel chocks for small aircraft (e.g., single-engine planes) are generally incompatible with large aircraft (e.g., military aircraft, cargo aircraft, larger commercial aircraft, etc.). The larger tires of large aircraft cannot properly engage a conventional wheel chock intended for smaller aircraft (e.g., by subsuming the wheel chock, by engaging too little of the chocking face and/or instead primarily resting on top of the wheel chock, etc.). Conversely, the same incompatibility exists between small aircraft and conventional wheel chocks intended for use with large aircraft. The smaller tires of small aircraft cannot properly engage a conventional wheel chock intended for larger aircraft (e.g., by engaging too little of the chocking face and/or instead primarily engaging the toe wall). Thus, there is a constant need for an improved wheel chock with a wider range of compatibility across aircraft sizes.

The subject matter claimed herein is not limited to examples that solve any disadvantages or that operate only in environments such as those described above. Rather, this background is only provided to illustrate one example technology area where some examples described herein may be practiced.

### SUMMARY

An aspect of the present disclosure relates to a reversible wheel chock that includes a body portion, a handle, and a base pad. The body portion can include: a bottom face; a front face and a rear face extending upward relative to the bottom face, the front face having a front wall height, and the rear face having a rear wall height equivalent to the front wall height; a spine forming a top surface parallel to the bottom face, the spine defining apertures; a first chocking face spanning a first surface distance between the spine and the front face; and a second chocking face spanning a second surface distance between the spine and the rear face, wherein the first surface distance and the second surface distance are between 3 and 4 times greater than the front and rear wall heights. The handle can be attachable to the body portion via the apertures. The base pad can be attached to the body portion adjacent to the bottom face.

In some examples, wherein the first surface distance and the second surface distance are sized to engage vehicle wheels with tire diameters ranging from 60 inches to 10 inches. In particular examples, the first surface distance and the second surface distance are equivalent. In at least one example, the first chocking face and the second chocking face include a respective angle relative to the front face and the rear face ranging from 25 degrees to 45 degrees. In one or more examples, the front wall height and the rear wall height range between 1 inch and 3 inches. In one example, the base pad is adhered to the bottom face. In at least one example, the reversible wheel chock can include a high visibility material integrally formed with at least one of the body portion or the handle. In some examples, the handle maintains an upright, self-standing position.

Another aspect of the present disclosure relates to an aviation wheel chock that includes a body portion and a handle. The body portion can include: a bottom face; a toe wall extending upward relative to the bottom face; a spine forming a top surface parallel to the bottom face, the spine defining apertures; and a chocking face spanning a surface distance between the spine and the toe wall, wherein the surface distance is sized to engage aircraft wheels with tire diameters ranging from sixty inches to ten inches. In some examples, the handle is attachable to the body portion via the apertures.

In one or more examples, the aviation wheel chock includes a trapezoidal cross-section. In some examples, the aviation wheel chock can further include a base pad attached to the body portion adjacent to the bottom face. In at least one example, the body portion includes a polyurethane material. In particular implementations, the body portion defines a plurality of core outs extending upward from the bottom face.

Yet another aspect of the present disclosure relates to a wheel chock. The wheel chock can include a body portion, a handle, and a base pad. The body portion can include: a bottom face including a plurality of core outs and defining a recess along a periphery of the bottom face; a toe wall extending upward relative to the bottom face; a spine forming a top surface parallel to the bottom face, the spine defining apertures; and a chocking face spanning a surface distance between the spine and the toe wall, wherein the surface distance is sized to engage aircraft wheels with tire diameters ranging from sixty inches to ten inches. The handle can extend through the apertures and into a pair of core outs of the plurality of core outs. The base pad can be disposed in the recess and attached to the bottom face, the base pad covering the plurality of core outs.

In some examples, the toe wall includes a toe wall height, and the surface distance is between 3 and 4 times greater than the toe wall height. In one example, the surface distance is between 4 inches and 7 inches. In at least one example, the body portion includes a length between 22 and 28 inches, the chocking face spanning an entirety of the length. In some examples, the body portion includes a flange around the recess; and the base pad protrudes below the flange to support the wheel chock on a ground surface. In certain examples, the handle includes a rigid portion and a semi-flexible portion. The semi-flexible portion can include a cable core, and the rigid portion can include a sheath positioned around the cable core.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1-3 respectively illustrate a perspective view, a side view, and a bottom view of an example wheel chock in accordance with one or more examples of the present disclosure;

FIGS. 4-5 respectively illustrate a front cross-sectional view (lengthwise) and a front perspective cross-sectional view (widthwise) of a wheel chock in accordance with one or more examples of the present disclosure;

FIGS. 6-8 respectively illustrate a bottom perspective view, a cross-sectional exploded view, and a cross-sectional view of another example wheel chock in accordance with one or more examples of the present disclosure.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

The following disclosure relates to a wheel chock. In some examples the wheel chock of the present disclosure includes a body portion. The body portion is sized and shaped to interface with a wheel—specifically a tire positioned about the wheel (e.g., to prevent rotation or movement of the wheel). The body portion can include various faces or surfaces. Some faces provide a shape or height to the wheel chock. Additionally or alternatively, some faces engage with other objects (e.g., by contacting the ground surface, a wheel surface, etc.). It will be appreciated that these faces can include various features (e.g., to enhance grip or traction relative to an object or supporting surface).

In particular examples, a wheel chock of the present disclosure is a highly compatible aviation wheel chock that can universally accommodate a wide variety of aircraft sizes. For example, the wheel chock of the present disclosure can includes faces that, in combination, allow proper chocking face engagement for small aircraft tires and large aircraft tires alike (e.g., aircraft tires ranging from about 10 inches in diameter to about 60 inches in diameter). For instance, a wheel chock of the present disclosure includes a chocking face with a larger surface area and a longer gradual sloping from peak to toe compared to conventional wheel chocks. Additionally, the wheel chock of the present disclosure includes a toe wall that allows small aircraft tires to properly engage the chocking face while still providing a sufficient bottom height to the chocking face for larger aircraft tires. In these or other examples, a wheel chock of the present disclosure includes a trapezoidal cross-section that can impart a desired universal fit for aircraft tires.

In certain examples, a handle is attachable to the body portion. The handle can include one or more graspable members that can support the weight of the body portion (e.g., when carrying or positioning the wheel chock in place). In some examples, the handle is rigid to allow specific configurations or positions. For instance, in particular implementations, the handle can maintain an upright, self-standing position such that the handle supports its own weight. In one or more examples, the handle is an elongated handle that remains at approximately hip height relative to a user such that a user need not bend down to grasp the handle.

In at least some examples, a wheel chock of the present disclosure includes a high visibility material. This high visibility material can include a myriad of different types of material (e.g., based on color luminance, photoluminescence, etc.). In some examples, the high visibility material can be integrally formed as part of the wheel chock, whether embedded in the body portion or the handle, or irremovably positioned over one or more surfaces of the wheel chock as a coating or spray-on application. In these or other examples, the high visibility material can lend to improved visibility of the wheel chock, particularly at night and/or during inclement weather.

The wheel chock can also include other features. For example, the wheel chock can include a variety of core outs (e.g., to reduce material consumption, decrease a product weight, and/or tune an amount of allowed flexure or deformation for the wheel chock). As another example, the wheel chock can include a base pad attached to the bottom face of the wheel chock (e.g., to contact or grip the ground surface).

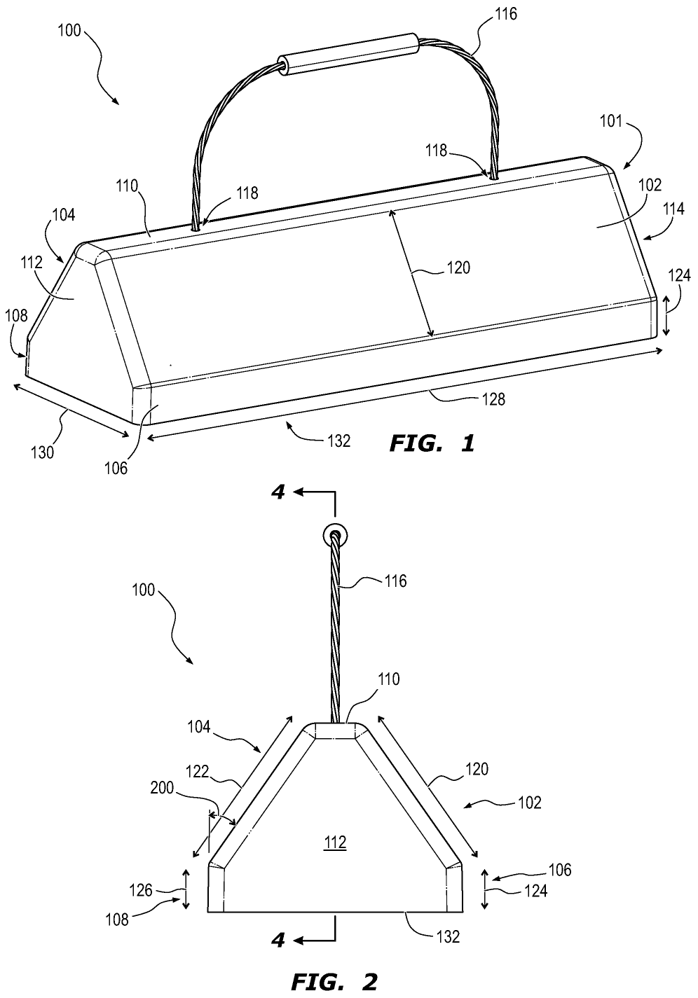

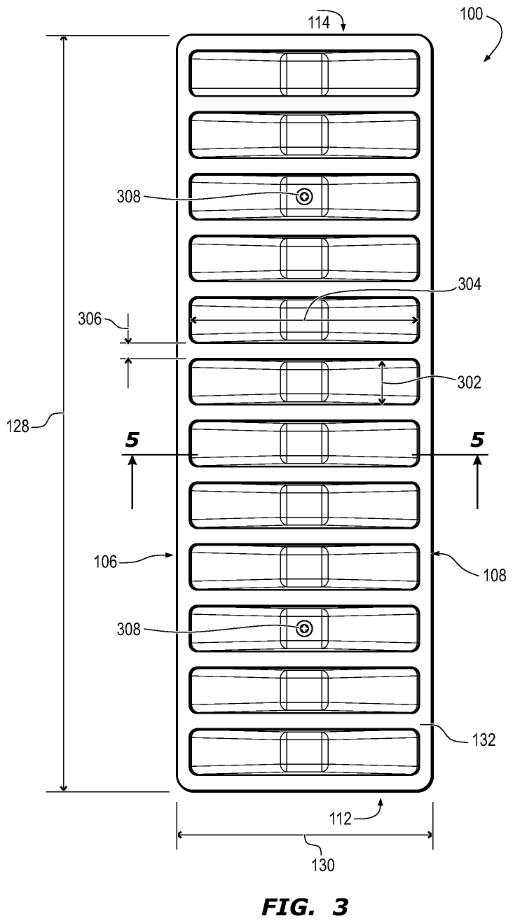

These and other examples are discussed below with reference to FIGS. 1-7. However, a person of ordinary skill in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1-3 respectively illustrate a perspective view, a side view, and a bottom view of an example wheel chock 100 in accordance with one or more examples of the present disclosure. As shown, the wheel chock 100 includes a body portion 101 and a handle 116. In some examples, the body portion 101 includes a structural frame, shell, and/or contact surfaces to engage and at least partially support a wheel of a vehicle (not shown). For example, a shape, size, and configuration of the body portion 101 can serve as a barrier or stop that prevents movement (e.g., rotational movement) of a vehicle wheel. As used herein, the term “wheel” refers to a combination of a tire and a wheel hub, where the tire is attached around the wheel hub and makes contact with a ground surface and various objects (including a wheel chock). Examples of a vehicle include an automobile, trailer, tractor, truck, crane, aircraft, and other wheeled vehicles. However, in some cases, a wheel chock of the present disclosure can also inhibit movement for non-wheeled vehicles (e.g., track vehicles like snowmobiles, track skid steers, etc.).

The body portion 101 can thus include a variety of different shapes and sizes, depending on the application and/or vehicle or wheel to be chocked. In certain examples, the body portion 101 is wedge shaped. In other examples, the body portion 101 is block shaped. In particular examples, the body portion 101 is trapezoidal shaped (e.g., with a particular geometry of faces that can accommodate engagement with a wide variety of aircraft tires). In some examples, and as shown, the body portion 101 is reversible (i.e., capable of chocking wheels via both front and rear sides). Further, in some examples, the body portion 101 can include hollow portions, cored out portions, one or more internal cavities, etc.

In particular examples, the body portion 101 is sized and shaped to engage an aircraft tire, including aircraft tires for both small aircraft and large aircraft. For example, the body portion 101 can include an array of geometry and dimensions that allow the wheel chock 100 to chock wheels of large and small aircraft alike. For instance, the wheel chock 100 can universally and singularly—solely and without a combination of other wheel chocks—restrain wheel movement for single engine planes, light aircraft (aircraft with less than a maximum gross takeoff weight of 12,500 pounds), large commuter aircraft and small regional jets, military aircraft, commercial aircraft or large jets, cargo aircraft, heavy aircraft (aircraft weighing more than 255,000 pounds), etc. Some specific example models of aircraft that the wheel chock 100 can be utilized for include the AIRBUS A380 commercial plane having a tire size of 56 inches in diameter and 21 inches in width, and the CESSNA Hawk XP having a tire size of 17.5 inches in diameter and 6 inches in width. Accordingly, the wheel chock 100 can provide a universal fit for a wide variety of aircraft sizes unlike conventional wheel chocks that have limited compatibility to specific size classes or categories of aircraft.

Specific surface dimensions of the wheel chock 100 are discussed further below. However, the wheel chock 100 can (overall) include a length 128 and a width 130. In some examples, the length 128 is sufficient to extend beyond one or both sides of a chocked wheel. That is, the length 128 can be greater than the width of an aircraft tire (e.g., for ergonomic removal and/or placement of the wheel chock 100 against an aircraft tire). In specific implementations, the length 128 is between 6 inches and 30 inches, between 10 inches and 28 inches, between 15 inches and 24 inches, between 20 inches and 25 inches, or between 22 inches and 28 inches. Further, in some examples, the width 130 can range between 5 inches and 20 inches, between 7 inches and 16 inches, between 6 and 10 inches, or between 10 inches and 15 inches.

In these or other examples, the body portion 101 can include a plastic material, a rubber material, a metal material, a composite material, or a combination thereof. In certain examples, the body portion 101 includes a urethane material (e.g., polyurethane). Additionally or alternatively, the body portion 101 can include a material with impact resistance, toughness, and/or load-bearing capabilities sufficient for chocking a wheel of a vehicle. In one or more examples, the body portion 101 includes a material that is resistant to chemicals (including aircraft fuel, lubricants, oils, etc.), ultraviolet light, weathering, and extreme temperatures (e.g., below 32 degrees Fahrenheit and/or above 100 degrees Fahrenheit). In at least some examples, the body portion 101 includes a molded material, a three-dimensional printed material, a cast material, a machined material, etc.

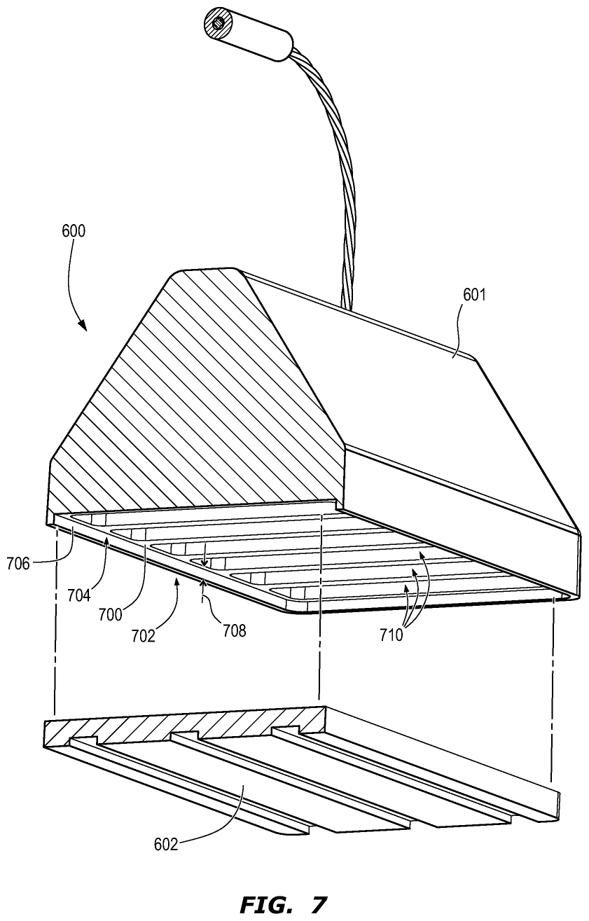

In more detail, the body portion 101 can include a bottom face 132 (i.e., a base) that is engageable with a support surface, such as the ground or field environment. In some examples, the bottom face 132 is flat or planar (as shown). However, in other examples, the bottom face 132 can include feet or other traction-enhancing features (e.g., ribs, spikes, protrusions, ridges). In particular examples (and as shown in FIGS. 6-8), the bottom face 132 can be attached to a base pad.

The body portion 101 can also include toe walls 106, 108 (e.g., front and rear walls). The toe walls 106, 108 can extend upward relative to the bottom face 132. In some examples, the toe walls 106, 108 are load-bearing surfaces (together with chocking faces 102, 104). For instance, smaller aircraft tires can engage both the chocking face 102 and the toe wall 106. In other examples, the toe walls 106, 108 are not load-bearing surfaces (but rather provide a height at which the chocking faces 102, 104 can engage a tire). For instance, larger aircraft tires may be sufficiently large such that a toe wall is not engaged. As used herein, the term “engage” refers to contact between two objects (e.g., an aircraft tire and the chocking face 102 of the wheel chock 100).

In these or other examples, the toe walls 106, 108 can respectively include toe wall heights 124, 126 (measured perpendicularly from the bottom face 132 to the bottom edge of the chocking faces 102, 104). In particular implementations, the toe wall heights 124, 126 can correspond to the threshold edge of the chocking faces 102, 104. Accordingly, the toe wall heights 124, 126 can be tuned to provide compatibility between large and small aircraft tires (e.g., ranging from 60 inches in diameter to 10 inches in diameter). For example, the toe wall heights 124, 126 can be tuned such that the chocking faces 102, 104 do not begin too high for small aircraft tires (thereby preventing engagement between a small aircraft tire and the chocking faces 102, 104). Similarly, the toe wall heights 124, 126 can be tuned such that the chocking faces 102, 104 do not begin too low for large aircraft tires (thereby reducing engagement with the chocking faces 102, 104). In specific implementations, the front wall height and the rear wall height range between 0.5 inches and 6 inches, between 1 inch and 5 inches, between 1 inch and 2 inches, or between 2 and four inches.

The body portion 101 can further include chocking faces 102, 104. A chocking face can include a wheel-engagement surface, a wedging wall, a stop surface, a contact surface, a tire-grip surface, etc. In particular implementations, the chocking faces 102, 104 are angled surfaces (relative to the toe walls 106, 108, which are positioned substantially vertical or perpendicular to a ground surface). That is, the chocking faces 102, 104 can be positioned at an angle 200 (relative to the toe walls 106, 108) that ranges between the vertical and horizontal angles (e.g., between 0 and 90 degrees from a vertical direction or plane associated with the toe walls 106, 108). In some examples the angle 200 ranges between 25 degrees and 45 degrees, between 10 degrees and 60 degrees, or between 35 degrees and 75 degrees.

Further, the chocking faces 102, 104 can include planar surfaces. Additionally or alternatively, the chocking faces 102, 104 can include curved portions (e.g., with a curvature or radius corresponding to a radius of wheel). In some examples, the chocking faces 102, 104 include traction-enhancing features (e.g., ribs, spikes, protrusions, ridges). Further, the chocking faces 102, 104 can include a surface area and/or angle of inclination that is tunable depending on the application and/or vehicle or wheel to be chocked. In these or other examples, the chocking faces 102, 104 can span an entirety of the length 128, which can also lend to improved versatility for chocking different aircraft tire sizes.

In particular examples, the chocking faces 102, 104 respectively include a first surface distance 120 and a second surface distance 122. A surface distance can be defined as the distance—measured perpendicularly—between the spine 110 and a toe wall (e.g., the toe walls 106, 108). In some examples, the first surface distance 120 and the second surface distance 122 are between 3 and 4 times greater than the toe wall heights 124, 126. This particular ratio of surface distance to toe wall height can help impart universal aircraft compatibility for the wheel chock 100. In particular, the foregoing ratio captures the structural relationship of the comparatively long, sloping surface of the chocking faces 102, 104 with respect to the shorter toe walls 106, 108 in a way that imparts the desired cross-compatibility for many different aircraft sizes. For example, the first surface distance 120 and the second surface distance 122 are sized to engage vehicle wheels with tire diameters ranging from 60 inches to 10 inches.

In some examples, the first surface distance 120 and the second surface distance 122 are equivalent. In alternative examples, the first surface distance 120 and the second surface distance 122 differ—in which case the toe wall heights 124, 126 can correspondingly differ (e.g., to accommodate larger size tires via one chocking face and smaller size tires via the other chocking face). In specific implementations, the first surface distance 120 and the second surface distance 122 are between 3 inches and 15 inches, between 4 inches and 7 inches, or between 5 and 6 inches.

Other implementations of a chocking face are herein contemplated. For example, in some embodiments, the body portion 101 includes a single chocking face (as opposed to the multiple chocking faces illustrated). The single chocking face can be positioned above at least one of the toe walls 106, 108. In some examples, the single chocking face adjoins a spine 110.

The body portion 101 can include a spine 110 forming a top surface of the wheel chock 100. In some examples, the spine 110 is parallel to the bottom face 132 and/or perpendicular to the toe walls 106, 108. In these or other examples, the spine 110 can adjoin the chocking faces 102, 104. In some examples, the spine 110 spans a distance (measured width-wise or parallel to the width 130) between the chocking faces 102, 104. In these examples, the spine 110 includes a width ranging from 0.5 inches to 5 inches, from 1 inch to 3 inches, or from 1 inch to 2 inches. The spine 110 can also include one or more apertures 118. The apertures 118 can include through-holes for receiving the handle 116 (discussed more below).

In addition to the body portion 101, the wheel chock 100 can include the handle 116. In particular examples, the handle 116 can include a rigid portion. In specific examples, the rigid portion of the handle constitutes an entirety of the handle 116 such that the handle 116 is a rigid handle. In other examples, a rigid portion of the handle includes an overmolding or grip portion. In at least one example, the handle 116 is sufficiently rigid to maintain an upright, self-standing position (e.g., such that the handle 116 does not collapse or bend under its own weight).

As used herein, the term “rigid” for a rigid portion or rigid handle refers to the inflexible or stiff qualities of the handle. For example, the handle 116 can maintain its shape and configuration (e.g., regardless of gravitational orientation or ambient weather conditions). Additionally or alternatively, a rigid portion can resist bending, deformation, or flexure. In this manner, the handle 116 can include a variety of advantages, particularly over loose, floppy rope-like tethers or handles. In particular, a rigid portion of the handle 116 can facilitate convenient and ergonomic grabbing, carrying, and/or manipulating the wheel chock 100. For instance, in one example, the handle 116 is an elongated handle that extends from the spine 110 upward to a hip height position of a user (e.g., a handle height ranging from one foot tall to four feet tall). In this example, a user can ergonomically pick up the wheel chock 100 via the handle 116 without having to bend down.

A rigid portion can also inhibit pinch points, entanglement, etc. that are typical of loose, floppy rope-like tethers. In some examples, the rigid portion(s) of the handle 116 can allow for movement of the handle 116 between fixed positions—namely a raised position for carrying the wheel chock 100 and a lowered position when the body portion 101 is chocked against a vehicle wheel). These and other aspects of the handle 116 are described below in relation to FIG. 4.

Other examples of the handle 116 are also herein contemplated. For example, (and as shown in the figures) the handle 116 can include a semi-rigid handle. As used herein, the term “semi-rigid” refers to a handle having a rigid portion (as described above) and another portion that is at least semi-flexible (i.e., partially flexible or partially stiff). Additionally or alternatively, a semi-rigid handle can include a combination of stiff and flexible materials and/or a specific type of material exhibiting both stiff and pliant properties. For instance, as explained below in relation to FIG. 4, a semi-rigid handle can include a first flexible portion (e.g., a semi-flexible core) and a second rigid portion (e.g., a stiffened sheath). Specifically, these semi-rigid handles can include a semi-flexible rope, cable, or chain at least partially encapsulated by a rigid sheath. In certain examples, a semi-rigid handle can be moved between fixed positions (e.g., a raised position for carrying the wheel chock and a lowered position when the body portion 101 is chocked against a vehicle wheel). Additionally or alternatively, a semi-rigid handle can, in some examples, maintain an upright or self-standing position. For example, the cable core (albeit semi-flexible) can be sufficiently stiff to maintain an upright or self-standing position in spite of the handle weight.

In some examples, a semi-rigid handle can be at least temporarily deformed in response to an applied force. Additionally or alternatively, a semi-rigid handle can include a predetermined shape or configuration to which the semi-rigid handle is inherently biased. For example, flexible portions of a semi-rigid handle may bow or flex in response to grasping or lifting the semi-rigid handle, but then return to its predetermined (or unaltered) state.

In at least one example, the wheel chock 100 (and/or the wheel chock 600 discussed below) can include a high visibility material. As used herein, the term “high visibility material” refers to visibility-enhancing material or a visual aid. This high visibility material can include a myriad of different types of material (e.g., based on color luminance, photoluminescence, etc.). For example, the high visibility material can include a pigment (e.g., a colorant) having a color luminance greater than 50 percent. Such pigment can correspond to a hue with a natural luminance above 50 percent. Additionally or alternatively, the color luminance can exceed 50 percent by modifying saturation and/or lightness of the pigment.

In some examples, the high visibility material includes a chargeable light emissive material. As used herein, the term “chargeable light emissive material” refers to one or more elements capable of being charged (and recharged) to persistently emit light after exposure to light from a light source—with light energy or photons—that may be visible or invisible. In some embodiments, a chargeable light emissive material includes a mixture, alloy, or combination of elements with chargeable, light-emitting properties. A chargeable light emissive material can include a coating or layer (e.g., a dip coating or paint layer). A chargeable light emissive material can also include a discontinuous or weighted application of sprayed or printed material (e.g., particles, pigments, strips, layers, flecks, grains, drops, etc.). An example of a chargeable light emissive material includes luminescent materials (whether organic and/or synthetic)—including fluorescent materials, phosphorescent materials, and/or chemiluminescent materials. It will be appreciated that at least fluorescent materials promptly exhibit photoluminescence very shortly after photoexcitation of the fluorescent materials. Additionally, as some particular examples, a chargeable light emissive material includes ultraviolet phosphors, blue light emitting diode phosphors, infrared emitting phosphors, Anti-Stokes phosphors (i.e., up-converters), glow-in-the-dark phosphors, x-ray phosphors, and storage phosphors. Other examples of a chargeable light emissive material include radioluminescent materials and cathodoluminescent materials.

It will be appreciated that a chargeable light emissive material can include a glow-in-the-dark material (e.g., a material that generates a luminous response or “glowing” output after being excited, such as via UV radiation from the sun). Then, when positioned in a darker environment (e.g., a cloudy environment, a foggy environment, a stormy environment, a nighttime environment), the glow-in-the-dark material can at least temporarily maintain its excited state and correspondingly generate a luminous response (e.g., without the need to reflect environmental light). For instance, a glow-in-the-dark or phosphorescent material is a material that has a fluorescence for which the average lifetime of the excited atoms is greater than 10⁻⁸ seconds.

In particular examples, the high visibility material can generate a luminous response (e.g., emit light at one or more wavelengths) perceivable to an unaided human eye when the chargeable light emissive material is exposed to an exciting agent at temperatures below incandescence. Such a luminous response can occur during oxidation or after exposure to light or other radiation. A luminous response can be modulated with electrical stimulation or other form of synthetic excitation in some examples (e.g., a high-intensity UV charging cabinet, a power supply connected to the high visibility material, a chemical agent, etc.). However, the high visibility material can include materials that can generate a luminous response independent of synthetic excitation. Rather, the natural elements (e.g., sunshine) can be sufficient for the high visibility material to generate the luminous response when the sunshine is gone.

In these or other examples, an “unaided human eye” is a naked eye of an average human observer having regular vision and that is not augmented or supplemented by lenses, microscopes, cameras, or other scopes or equipment used to discern wavelengths beyond the natural human eye. In certain examples, the luminous response of the high visibility material may be visible to the unaided human eye in darker environments, particularly at night and/or during inclement weather. In some embodiments, the unaided human eye, as referred to herein, can detect light of wavelengths from about 342 nanometers to about 770 nanometers.

In some examples, the high visibility material is integrally formed as part of the wheel chock (whether embedded in the body portion 101 or the handle 116, or irremovably positioned over one or more surfaces of the wheel chock 100 as a coating, molding, or spray-on application). In these or other examples, the high visibility material can lend to improved visibility of the wheel chock 100, particularly at night and/or during inclement weather. Furthermore, in some examples, only the handle 116 includes the high visibility material. In other examples, only one or more elements (e.g., one or more surfaces) of the body portion 101 include the high visibility material. Still, in other examples, the body portion 101 and the handle 116 both include the high visibility material.

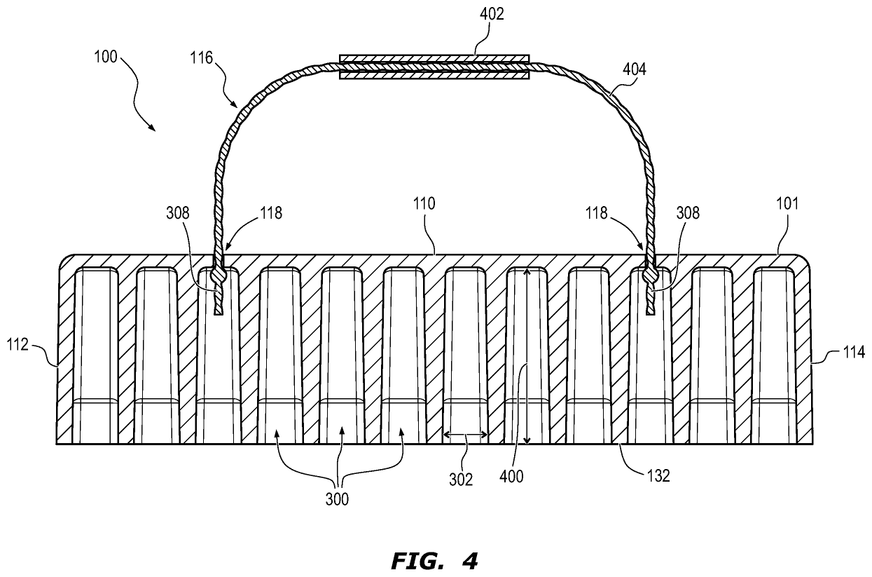

As shown in FIG. 3, the bottom face 132 can include one or more core outs 300. The core outs 300 can include slotted areas, cavities, voids, etc. that are formed (or subtracted via machining processes). The core outs 300 can be sized and shaped to reduce material consumption, decrease a product weight, and/or tune an amount of allowed flexure or deformation for the wheel chock 100. For example, increased a webbing thickness 306—namely the amount of material dividing the core outs 300—can lend to increased rigidity (i.e., reduced flexibility) of the wheel chock 100. Conversely, decreased webbing thickness 306 can lend to increased flexibility (i.e., reduced rigidity) of the wheel chock 100. The webbing thickness 306 in particular can define a length 302 of the core outs 300 (the length 302 being measured as a distance between opposing walls or webbing faces along the direction of the length 128 of the wheel chock 100).

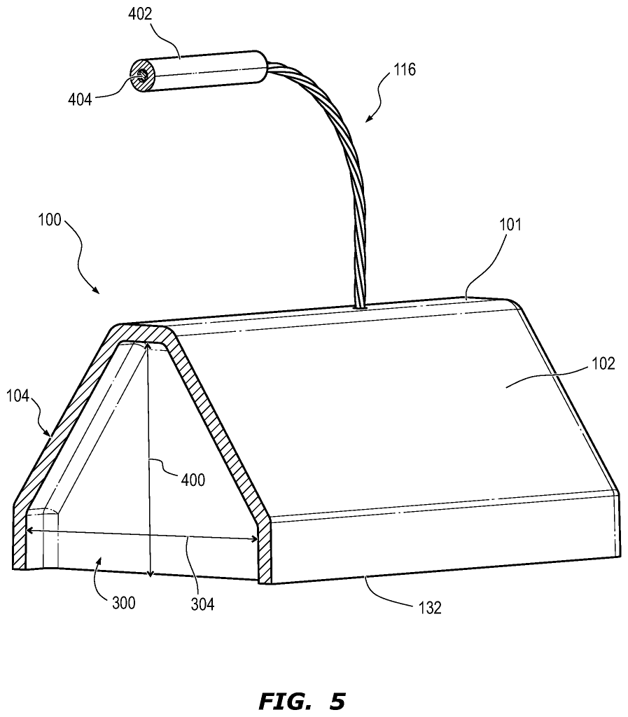

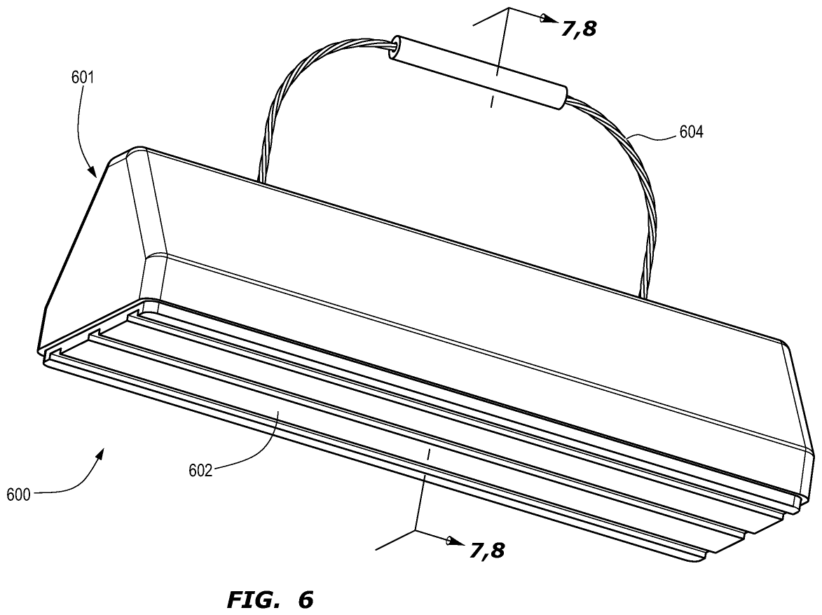

Similarly, the core outs 300 can span a width 304. At a bottom portion of the core outs 300, the width 304 can span most of the width 130 of the wheel chock 100 (less the wall thickness of the toe walls 106, 108). As the core outs 300 proceed upward from the bottom face 132, the width 304 can taper in some examples (e.g., as a function of the wheel chock cross-sectional profile as seen in FIG. 5).

Further shown in FIG. 3, handle ends 308 can extend through the apertures 118 (shown in FIG. 1) and into a pair of core outs of the core outs 300. Interaction between the handle ends 308 and the wheel chock 100 are discussed further below in relation to FIG. 4.

The wheel chock 100 can include additional or alternative features that are not expressly shown in the figures of the present disclosure. For example, the wheel chock 100 can include a hand grip. The hand grip can include a slotted portion defined by the body portion 101. In these or other examples, the hand grip can be positioned at an end portion 112 (opposite an end portion 114). In particular examples, the hand grip can allow a second hand of a user to assist in carrying or manipulating the wheel chock 100. As another example, the wheel chock 100 can include one or more portions (e.g., surfaces) for placing custom logos thereon.

Any of the features, components, and/or parts, including the arrangements and configurations thereof shown in FIGS. 1-3 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 1-3.

FIGS. 4-5 respectively illustrate a front cross-sectional view (lengthwise) and a front perspective cross-sectional view (widthwise) of the wheel chock 100 in accordance with one or more examples of the present disclosure. These figures provide additional detail with respect to the handle 116 and the core outs 300, each discussed in turn.

As mentioned above, the handle 116 can include a wide variety of different handles, including semi-rigid handles. In some examples, the handle 116 can include a rigid portion 402 and a semi-flexible portion 404.

In some examples, the rigid portion 402 can include a sheath. The sheath can at least partially encapsulate or cover the semi-flexible portion 404. In some examples, the sheath entirely encapsulates the semi-flexible portion 404 (e.g., along an entire length of the semi-flexible portion 404). In these or other examples, the sheath is a rigid, hardened material. The rigid material of the sheath can allow ergonomic grasping of the handle 116. In alternative examples, the sheath is a flexible material, a cushioning material (e.g., a hand cushion for grasping the handle 116), a foam material, a fabric material, a plastic material, a moldable material, etc. In particular examples, the sheath includes a high visibility material.

In some examples, the semi-flexible portion 404 is a cable core. As a cable core, the semi-flexible portion 404 can include one or more strands of wire material. In certain examples, the cable core includes a plurality of wires concentrically laid around (or braided about) a center wire. In some examples, the cable core can include a predetermined shape or configuration. In these or other examples, the cable core can maintain an upright, self-standing position (e.g., without user intervention or an applied force). In the upright, self-standing position, the cable core can be positioned in a permanently “raised” position (where the handle maintains a gap or spacing away from the body portion 101). Additionally or alternatively, the semi-flexible portion 404 can be moved between raised and lowered positions, such as by pushing downward to push the handle 116 into the interior portion of the wheel chock 100. It will be appreciated that, in some examples, the cable core is partially flexible—due to the cable core being able to at least partially bend, bow, or laterally move as allowed by the cable wire(s) and flexibility and/or gauge of the wire material.

In alternative examples, the semi-flexible portion 404 can include other types of material. For example, the semi-flexible portion 404 can include a chain core that has a set of connected chain links (e.g., metal links) attached together in series. As another example, the semi-flexible portion 404 can include one or more strands of rope material (e.g., a polypropylene material, a nylon material, a polyester material, a polyethylene material, an aramid material, an acrylic material, etc.). In such an example, the chain core and/or the rope core can be at least partially stiffened or otherwise arranged to maintain an upright, self-standing position. For instance, certain chain links may be welded together or certain rope strands may be tensioned or wound with a predetermined twist rate to impart stiffness qualities.

Further shown (particularly in FIG. 4), handle ends 308 corresponding to the handle 116 can include an interference fit relative to the apertures 118 to inhibit removal of the handle 116 from the body portion 101 once inserted through the apertures 118. For instance, the handle ends 308 can include a bulged portion that can be forcibly pushed/pulled through the apertures 118 during assembly (where the bulged portion includes a diameter larger than the diameter of the apertures 118). In one or more examples, the bulged portion can include a cable knot, a soldered portion, etc. to impart localized size increase. In this manner, the handle 116 can support the weight of the body portion 101 when carrying the wheel chock 100 while also preventing the handle 116 from detaching from the body portion 101.

FIGS. 4-5 additionally illustrate the core outs 300. As shown, the core outs 300 can include the length 302, which can taper (or narrow) along the height 400 as the height increases from the bottom face 132. Similarly, the width 304 of the core outs 300 can taper along the height 400 as the height increases from the bottom face 132. In some examples, the width 304 of the core outs 300 decreases with height away from the bottom face 132 due to the trapezoidal cross-sectional profile of the wheel chock 100, particularly the angled surfaces of the chocking faces 102, 104.

Any of the features, components, and/or parts, including the arrangements and configurations thereof shown in FIGS. 4-5 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 4-5.

As mentioned above, some examples of a wheel chock can include a base pad. In accordance with one or more such examples, FIGS. 6-8 respectively illustrate a bottom perspective view, a cross-sectional exploded view, and a cross-sectional view of another example wheel chock 600. As shown, the wheel chock 600 includes a body portion 601 and a handle 604. The handle 604 is the same as or similar to the handle 116 discussed above. Likewise, the body portion 601 is similar to the body portion 101 and can include the same or similar features discussed above in relation to FIGS. 1-5. In addition (and as will be discussed further below), the body portion 601 is adapted to attach to a base pad 602.

The wheel chock 600 can include a base pad 602. As used herein, the term “base pad” refers to a component attachable to a bottom face 700 of the wheel chock 600. The base pad 602 can serve as a base surface, contact surface, grip surface, cushion surface, protective surface, etc. for the wheel chock 600. The base pad 602 can also include a cover surface (e.g., that covers core outs 710, which are the same as or similar to the core outs 300 discussed above). The base pad 602 can further include a variety of different materials, such as a rubber, plastic, metal, or composite material. The base pad 602 can also include a wide variety of material properties to impart a desired impact resistance, toughness, friction or grip-enhancing qualities, etc.

The base pad 602 can be attached to the bottom face 700 in various ways. In some examples, the base pad 602 is fastened to the bottom face 700 via fasteners and associated threaded inserts or engaging surfaces in the body portion 601. In at least one example, however, the base pad 602 can be adhered to the bottom face 700 (e.g., via cyanoacrylate). By adhering the base pad 602 to the bottom face 700 in lieu of fasteners, the wheel chock 600 can be a FOD-compliant wheel chock (e.g., according to various aviation quality control standards and equipment safety protocols for the prevention of foreign object debris or foreign object damage (“FOD”)).

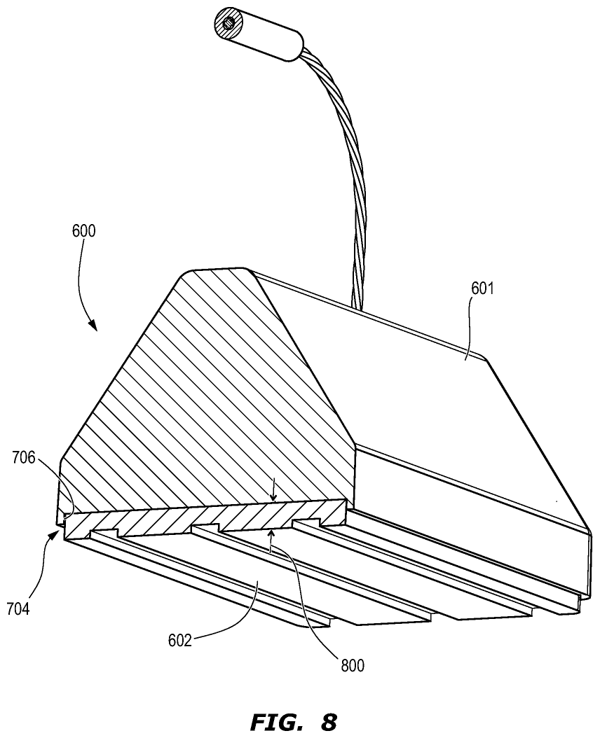

In these or other examples, the body portion 601 can be adapted in various ways to attach to the base pad 602. In some examples (and as shown specifically in FIG. 7), the bottom face 700 can include a periphery 702. Along the periphery 702, the bottom face 700 can define a recess 704. The recess 704 can be sized and shaped to receive the base pad 602. Disposed in the recess 704, the base pad 602 can be adhered or otherwise attached to the bottom face 700.

In these or other examples, the body portion 601 can include a flange 706 extending along the periphery 702, thereby at least partially defining the recess 704. In one or more examples, the flange 706 includes an overhang or lip that can at least partially cover the attachment interface between the base pad 602 and the bottom face 700. The flange 706 can have a flange height 708 measured from the bottom face 700. In one or more examples, the flange height 708 (which corresponds to the depth of the recess 704) can range between 1/16 inch and 2 inches, between ⅛ inch and 1 inch, or between ¼ inch and ½ inch.

In particular implementations, the base pad 602 can protrude below the flange 706 to support the wheel chock 600 on a ground surface. That is, the base pad 602 can have a thickness 800 that exceeds the flange height 708. Alternatively, in some examples, a bottom surface of the base pad 602 be flush with a bottom surface of the flange 706 (in which case, the flange height 708 and the thickness 800 of the base pad 602 can be approximately equivalent).

Any of the features, components, and/or parts, including the arrangements and configurations thereof shown in FIGS. 6-8 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 6-8.

The foregoing description, for purposes of explanation, used specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not intended to be exhaustive or to limit the examples to the precise forms disclosed.

It will be apparent to one of ordinary skill in the art that many modifications and variations are possible in view of the above teachings. Indeed, various inventions have been described herein with reference to certain specific aspects and examples. However, they will be recognized by those skilled in the art that many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.” Additionally, the terms “about” or “approximately” should be interpreted as +/−10 percent unless otherwise stated.

1. A reversible wheel chock, comprising:
a body portion comprising:
a bottom face;
a front face and a rear face extending upward relative to the bottom face, the front face having a front wall height, and the rear face having a rear wall height equivalent to the front wall height;
a spine forming a top surface parallel to the bottom face, the spine defining apertures;
a first chocking face spanning a first surface distance between the spine and the front face; and
a second chocking face spanning a second surface distance between the spine and the rear face,
wherein the first surface distance and the second surface distance are between 3 and 4 times greater than the front and rear wall heights;
a handle attachable to the body portion via the apertures; and
a base pad attached to the body portion adjacent to the bottom face.

2. The reversible wheel chock of claim 1, wherein the first surface distance and the second surface distance are sized to engage vehicle wheels with tire diameters ranging from 60 inches to 10 inches.

3. The reversible wheel chock of claim 1, wherein the first surface distance and the second surface distance are equivalent.

4. The reversible wheel chock of claim 1, wherein the first chocking face and the second chocking face comprise a respective angle relative to the front face and the rear face ranging from 25 degrees to 45 degrees.

5. The reversible wheel chock of claim 1, wherein the front wall height and the rear wall height range between 1 inch and 3 inches.

6. The reversible wheel chock of claim 1, wherein the base pad is adhered to the bottom face.

7. The reversible wheel chock of claim 1, further comprising a high visibility material integrally formed with at least one of the body portion or the handle.

8. The reversible wheel chock of claim 1, wherein the handle maintains an upright, self-standing position.

9. An aviation wheel chock, comprising:
a body portion comprising:
a bottom face;
a toe wall extending upward relative to the bottom face;
a spine forming a top surface parallel to the bottom face, the spine defining apertures; and
a chocking face spanning a surface distance between the spine and the toe wall, wherein the surface distance is sized to engage aircraft wheels of varying diameters; and
a handle attachable to the body portion via the apertures.

10. The aviation wheel chock of claim 9, wherein the aviation wheel chock comprises a trapezoidal cross-section.

11. The aviation wheel chock of claim 9, further comprising a base pad attached to the body portion adjacent to the bottom face.

12. The aviation wheel chock of claim 9, wherein the body portion comprises a polyurethane material.

13. The aviation wheel chock of claim 9, wherein the body portion defines a plurality of core outs extending upward from the bottom face.

14. A wheel chock, comprising:
a body portion comprising:
a bottom face comprising a plurality of core outs and defining a recess along a periphery of the bottom face;
a toe wall extending upward relative to the bottom face;
a spine forming a top surface parallel to the bottom face, the spine defining apertures; and
a chocking face spanning a surface distance between the spine and the toe wall, wherein the surface distance is sized to engage aircraft wheels;
a handle extending through the apertures and into a pair of core outs of the plurality of core outs; and
a base pad disposed in the recess and attached to the bottom face, the base pad covering the plurality of core outs.

15. The wheel chock of claim 14, wherein:
the toe wall comprises a toe wall height; and
the surface distance is between 3 and 4 times greater than the toe wall height.

16. The wheel chock of claim 14, wherein the surface distance is between 4 inches and 7 inches.

17. The wheel chock of claim 14, wherein the body portion comprises a length between 22 inches and 28 inches, the chocking face spanning an entirety of the length.

18. The wheel chock of claim 14, wherein:
the body portion includes a flange around the recess; and
the base pad protrudes below the flange to support the wheel chock on a ground surface.

19. The wheel chock of claim 14, wherein the handle comprises a rigid portion and a semi-flexible portion.

20. The wheel chock of claim 19, wherein:
the semi-flexible portion comprises a cable core; and
the rigid portion comprises a sheath positioned around the cable core.

21. A wheel chock, comprising:
a body portion comprising:
a bottom face;
a chocking face sized and shaped to engage a vehicle wheel; and
a plurality of walls adjacent to the chocking face and extending upward relative to the bottom face; and
a chargeable light emissive material included in at least part of the body portion.

22. The wheel chock of claim 21, wherein the chargeable light emissive material is included in the chocking face and each wall of the plurality of walls.

23. The wheel chock of claim 21, wherein the chargeable light emissive material is integrally formed with the at least part of the body portion.

24. The wheel chock of claim 21, wherein the vehicle wheel is an industrial utility vehicle wheel.
